(19) United States
(12) Patent Application Publication
(10) Pub. No.: US 2010/0151794 A1
(43) Pub. Date: Jun. 17, 2010

(54) METHOD AND APPARATUS OF COMPUTING PROBABILITY OF INTERFERENCE IN OVERLAY SYSTEM AND UNDERLAY SYSTEM

(76) Inventors: Ho Kyung SON, Daejeon (KR); Heon Jin HONG, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/546,876

(22) Filed: Aug. 25, 2009

(30) Foreign Application Priority Data
Dec. 16, 2008 (KR) 10-2008-0127930

(51) Int. Cl. H04B 17/00

(52) U.S. Cl. 455/67.13

(57) ABSTRACT

A method of computing a probability of interference in an overlay system and an underlay system, the method including: setting an input parameter corresponding to each of an interfered receiver, an interfering transmitter, an opposing transmitter, and a target receiver; computing a strength of a received signal, received in the interfered receiver from the opposing transmitter; computing a transmission signal level from a victim link in the interfering transmitter; determining whether the interfering transmitter transmits a signal in the overlay system; determining a transmission power of the interfering transmitter based on the computed transmission signal level in the underlay system; computing a strength of an interference signal depending on whether the interfering transmitter transmits the signal and the transmission power of the interfering transmitter; and computing the probability of interference using the computed strength of the received signal and the computed strength of the interference signal.

### CROSS-REFERENCE TO RELATED APPLICATION

This application claims priority from Korean Patent Application No. 10-2008-0127930, filed on Dec. 16, 2008, in the Korean Intellectual Property Office, the entire disclosure of which is incorporated herein by reference.

### BACKGROUND OF THE INVENTION

1. Field of the Invention

The present invention relates to a method and apparatus of computing a probability of interference in an overlay system and an underlay system, and more particularly, to a method and apparatus of computing a probability of interference in an overlay system and an underlay system which, when a system using a spectrum based on an overlay scheme is an interferer, may sense a strength of an ambient signal before transmitting a signal, and determine whether to transmit the signal based on a level of the sensed strength, and when a system using a spectrum based on an underlay scheme is an interferer, may sense a strength of an ambient signal before transmitting a signal, and determine a transmission power level based on a level of the sensed strength.

2. Description of Related Art

An analysis on an interference between general wireless communication systems may generally be based on computation of a probability of interference using a Monte-Carlo method.

A Monte-Carlo method may be used to designate all parameters associated with an interference environment, and statistically compute a probability of interference. Although a Monte-Carlo method may be complex, and a difference in a probability of interference may exist depending on an input parameter value, all interference environments may be simulated.

Currently, an interference analysis method using a Monte-Carlo method has been provided. The interference analysis method may determine a possibility sharing of a frequency, and provide a technical parameter such as a transmission mask for frequency sharing, through an interference analysis with an existing wireless service system that uses an identical or adjacent band of a corresponding frequency.

FIG. 1 is a block diagram illustrating an example when an interference between wireless communication systems occurs.

Referring to FIG. 1, it may be assumed that an interfering antenna system 20 is an antenna system that interferes with an interfered antenna system 10, and the interfered antenna system 10 is an antenna system to be analyzed with respect to interference. In this instance, the interfered antenna system 10 may include an interfered receiver 11 and opposing an opposing transmitter 12. Also, the interfering antenna system 20 may include an interfering transmitter 21 and a target receiver 22.

A Desired Receiving Signal Strength (DRSS) may denote a strength of a signal received by the interfered receiver 11 from the opposing transmitter 12. An Interfering Receiving Signal Strength (IRSS) may denote a strength of a signal received by the interfered receiver 11 from the interfering transmitter 21. In this instance, the signal received by the interfered receiver 11 from the interfering transmitter 21 may cause an interference in the interfered receiver 11.

Also, an interfered link 13 may indicate a link between the interfered receiver 11 and the opposing transmitter 12, and an interfering link 23 may indicate a link between the interfered receiver 11 and the interfering transmitter 21.

Hereinafter, a method of computing a probability of interference in an antenna system using a Monte-Carlo method in a conventional art is described.

A parameter of each of the interfered receiver 11, the opposing transmitter 12, the interfering transmitter 21, and the target receiver 22 may be set. A link parameter between the interfered receiver 11 and the opposing transmitter 12, and a link parameter between the interfering transmitter 21 and the target receiver 22 may be set.

Also, the DRSS and the IRSS may be computed.

In this instance, the DRSS may be represented as,

DRSS=p_{wt supplied}+g_{wt→vr}−pl_{wt→vr}(fᵥᵣ)+g_{vr→wt} [Equation 1]

where p_{wt supplied} may denote a power supplied to the opposing transmitter 12. Also, g_{wt→vr} and pl_{wt→vr} may denote an antenna gain from the opposing transmitter 12 to the interfered receiver 11 and a path loss between the opposing transmitter 12 and the interfered receiver 11, respectively.

In general, an interference mechanism may be divided into a blocking, a unwanted emission, an intermodulation, and the like. The IRSS for each interference mechanism may be represented as,

IRSS_{block,i}=(p_{itsupplied}+g_{itPC}+g_{it→vr}−pl_{it→vr}−aᵥᵣ+g_{vr→it}) [Equation 2]

where IRSS_{block,i} may denote a strength of an interference blocking signal, received from an i^{th} interfering transmitter, and p_{it supplied} may denote a power supplied to the interfering transmitter 21. g_{itpc} may denote a power control gain with respect to the interfering transmitter 21 in a power control function. p_{it→vr} and g_{vr→it} may denote an antenna gain towards the interfering transmitter 21 and the interfering transmitter 21 to the interfered receiver 11, and an antenna gain from the interfered receiver 11 to the interfering transmitter 21, respectively. Also, aᵥᵣ and pl_{it→vr} may denote a blocking attenuation of the interfered receiver 11 and a path loss between the interfered receiver 11 and the interfering transmitter 21, respectively.

IRSS_{unwanted}_{_{—}}ᵢ=(emissionᵢₜ(fᵢₜ, fᵥᵣ)+g_{it→vr}−pl_{it→vr}(fᵥᵣ)+g_{vr→it}) [Equation 3]

where IRSS_{unwanted}_{_{—}}_{,i} may denote a strength of an interference signal received in the interfered receiver 11 from an unwanted emission of the i^{th} interfering transmitter.

Also, emissionᵢₜ(fᵢₜ, fᵥᵣ) may denote a strength of an interference signal received from a bandwidth of the interfered receiver 11, and may be obtained by a function of a transmission power strength of the interfering transmitter 21, an unwanted emission mask, and the like.

I_{i,j}RSS_{intermod}=2*IᵢRSSᵢₙₜ+IⱼRSSᵢₙₜ−3intermod−3sensᵥᵣ−9 dB [Equation 4]

where I_{i,j}RSS_{intermod} may denote a strength of an intermodulation interference signal received from the i^{th} interfering transmitter and an j^{th} interfering transmitter, intermod may denote a 3^{rd} intermodulation attenuation, and sensᵥᵣ may denote a sensitivity of the interfered receiver 11.

Accordingly, a probability of interference (P) may be computed to be equal to or less than a Carrier-to-Interference ratio (C/I) required by the DRSS/IRSS, when the DRSS is received at a value equal to or greater than a receive sensitivity level.

That is, when a particular parameter, which is not a fixed value, from among the input parameters is inputted, each parameter of a corresponding range may be applied, the DRSS and the IRSS may be computed, and a number of times that the DRSS/IRSS is equal to or less than the threshold value (C/I) may be divided into a total number of times to compute the probability of interference, which is represented as,

$$P = P \{ \frac{DRSS}{IRSS} < \frac{C}{I} \vert D R S S > sens \} . \qquad [ Equation 5 ]$$

The above-described method of computing a probability of interference in an antenna system using a Monte-Carlo method in a conventional art may have an advantage that a probability of interference is computed based on an actual environment. However, in the above-described method, a probability of interference with respect to a system using a spectrum based on an overlay and underlay scheme may not be computed.

### SUMMARY OF THE INVENTION

The present invention provides a method and apparatus of computing a probability of interference in an overlay system and an underlay system which, when a system using a spectrum based on an overlay scheme is an interferer, may sense a strength of an ambient signal before transmitting a signal, and determine whether to transmit the signal based on a level of the sensed strength, and when a system using a spectrum based on an underlay scheme is an interferer, may sense a strength of an ambient signal before transmitting a signal, and determine a transmission power level based on a level of the sensed strength.

The present invention also provides a method and apparatus of computing a probability of interference in an overlay system which, when a system using a spectrum based on an overlay scheme is an interferer, may sense a strength of an ambient signal before transmitting a signal, and determine whether to transmit the signal based on a level of the sensed strength.

The present invention also provides a method and apparatus of computing a probability of interference in an underlay system which, when a system using a spectrum based on an underlay scheme is an interferer, may sense a strength of an ambient signal before transmitting a signal, and determine a transmission power level based on a level of the sensed strength.

According to an aspect of the present invention, there is provided a method of computing a probability of interference in an overlay system and an underlay system, the method including: setting an input parameter corresponding to each of an interfered receiver, an interfering transmitter, an opposing transmitter, and a target receiver; computing a strength of a received signal, received in the interfered receiver from the opposing transmitter, using the input parameter; computing a transmission signal level from a victim link in the interfering transmitter; determining whether the interfering transmitter transmits a signal in the overlay system; determining a transmission power of the interfering transmitter based on the computed transmission signal level in the underlay system; computing a strength of an interference signal, received in the interfered receiver, depending on whether the interfering transmitter transmits the signal and the transmission power of the interfering transmitter; and computing the probability of interference where the interfering transmitter affects the interfered receiver using the computed strength of the received signal and the computed strength of the interference signal.

According to another aspect of the present invention, there is provided a method of computing a probability of interference in an overlay system, the method including: sensing a strength of an ambient signal before transmitting a signal, when a system using a spectrum based on an overlay scheme is an interferer; determining whether to transmit a signal based on the sensed strength of the ambient signal; and computing the probability of interference affecting an interfered receiver depending on a result of the determining whether to transmit.

According to still another aspect of the present invention, there is provided a method of computing a probability of interference in an underlay system, the method including: sensing a strength of an ambient signal before transmitting a signal, when a system using a spectrum based on an underlay scheme is an interferer; determining a transmission power level based on the sensed strength of the ambient signal; and computing the probability of interference affected on an interfered receiver depending on the determined transmission power level.

According to yet another aspect of the present invention, there is provided an apparatus of computing a probability of interference in an overlay system and an underlay system, the apparatus including: an input parameter setting unit to set an input parameter corresponding to each of an interfered receiver, an interfering transmitter, opposing transmitter, and a target receiver; a received signal strength computation unit to compute a strength of a received signal, received in the interfered receiver from the opposing transmitter, using the input parameter; a transmission signal level computation unit to compute a transmission signal level from a victim link in the interfering transmitter; a transmission determination unit to determine whether the interfering transmitter transmits a signal in the overlay system; a transmission power determination unit to determine a transmission power of the interfering transmitter based on the computed transmission signal level in the underlay system; an interference signal computation unit to compute a strength of an interference signal, received in the interfered receiver, depending on whether the interfering transmitter transmits the signal and the transmission power of the interfering transmitter; and an interference probability computation unit to compute the probability of interference where the interfering transmitter affects the interfered receiver using the computed strength of the received signal and the computed strength of the interference signal.

According to another aspect of the present invention, there is provided an apparatus of computing a probability of interference in an overlay system, the apparatus including: a signal sensing unit to sense a strength of an ambient signal before transmitting a signal, when a system using a spectrum based on an overlay scheme is an interferer; a transmission determination unit to determine whether to transmit the signal based on the sensed strength of the ambient signal; and an interference probability computation unit to compute the probability of interference affected on an interfered receiver depending on a result of the determining whether to transmit.

According to still another aspect of the present invention, there is provided an apparatus of computing a probability of interference in an underlay system, the apparatus including: a signal sensing unit to sense a strength of an ambient signal before transmitting a signal, when a system using a spectrum based on an underlay scheme is an interferer; a transmission power level determination unit to determine a transmission power level based on the sensed strength of the ambient signal; and an interference probability computation unit to compute the probability of interference affected on an interfered receiver depending on the determined transmission power level.

According to the present invention, a method and apparatus of computing a probability of interference in an overlay system and an underlay system may compute a probability of interference that affects an interfered receiver depending on a strength of an interference signal, received in the interfered receiver from an interferer, based on a new wireless communication service using the overlay system and the underlay system.

Also, according to the present invention, when a system using a spectrum based on an overlay scheme is an interferer, a method and apparatus of computing a probability of interference in an overlay system may sense a strength of an ambient signal before transmitting a signal, and determine whether to transmit a signal based on a level of the sensed strength.

Also, according to the present invention, when a system using a spectrum based on an underlay scheme is an interferer, a method and apparatus of computing a probability of interference in an underlay system may sense a strength of an ambient signal before transmitting a signal, and determine a transmission power level based on a level of the sensed strength.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating an example when an interference between wireless communication systems occurs;

FIG. 2 is a diagram illustrating an example of an interference analysis scenario in an overlay system according to an embodiment of the present invention;

FIG. 3 is a flowchart illustrating a method of computing a probability of interference in an overlay system according to an embodiment of the present invention;

FIG. 4 is a flowchart illustrating an example of an operation of determining whether an interferer performs transmission in an overlay system according to an embodiment of the present invention;

FIG. 5 is a flowchart illustrating a method of computing a probability of interference in an underlay system according to another embodiment of the present invention;

FIG. 6 is a flowchart illustrating an example of an operation of determining an interference transmission level in an underlay system according to another embodiment of the present invention;

FIG. 7 is a block diagram illustrating a configuration of an apparatus of computing a probability of interference in an overlay system and an underlay system according to an embodiment of the present invention;

FIG. 8 is a block diagram illustrating a configuration of an apparatus of computing a probability of interference in an overlay system according to another embodiment of the present invention; and

FIG. 9 is a block diagram illustrating a configuration of an apparatus of computing a probability of interference in an underlay system according to still another embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

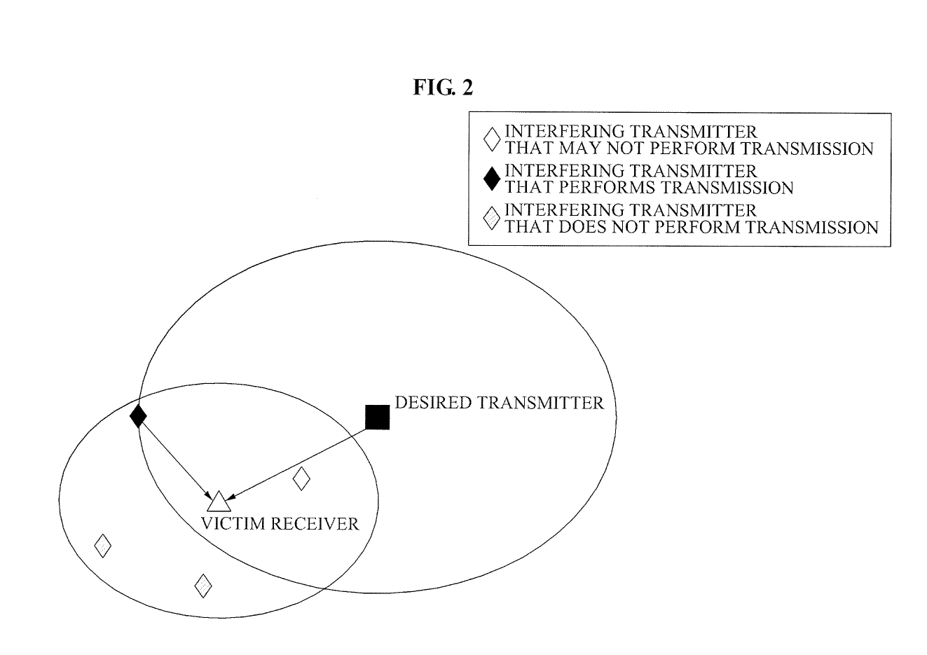

FIG. 2 is a diagram illustrating an example of an interference analysis scenario in an overlay system according to an embodiment of the present invention.

Referring to FIG. 2, in the overlay system, a high-level signal that may generate an interference may be used. In the overlay system, however, a signal of each device may exist to prevent other authorized users from being interfered with by retrieving a time, a frequency, and a band which is not spatially used. Accordingly, a signal level is to be sensed in a particular band, before transmitting a signal in the band.

That is, the overlay system may sense a strength of an ambient signal before transmitting a signal, and determine whether to transmit the signal depending on the sensed strength.

Accordingly, a transmitter that does not transmit since a sensed strength is greater than a predetermined level, a transmitter that transmits since a sensed level is less than a threshold level, and a transmitter that may not transmit since an adjacent transmitter performs transmission may exist.

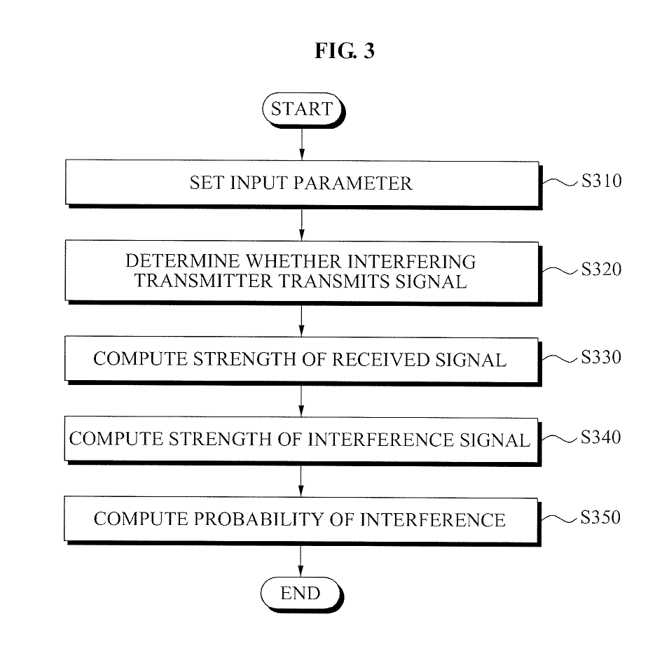

FIG. 3 is a flowchart illustrating a method of computing a probability of interference in an overlay system according to an embodiment of the present invention.

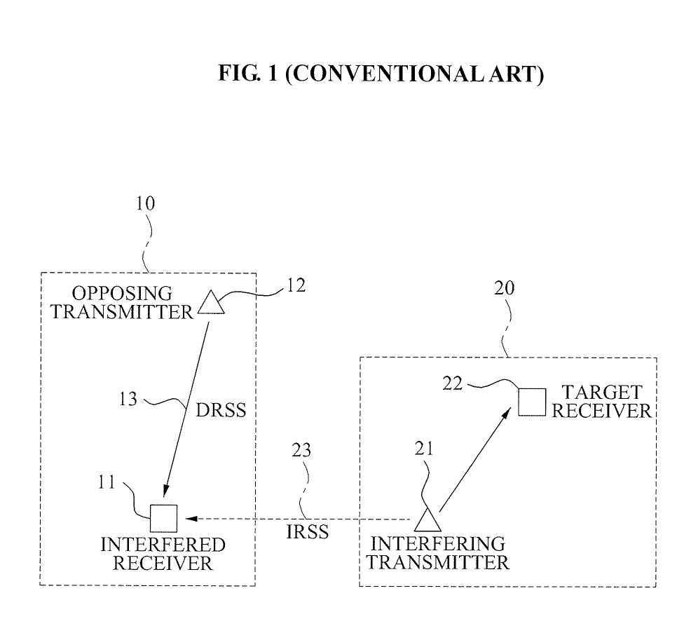

Referring to FIGS. 1 and 3, in operation S310, the overlay system may set an input parameter corresponding to each of an interfered receiver 11, an interfering transmitter 21, an opposing transmitter 12, and a target receiver 22. That is, in operation S310, the overlay system may generate the interfered receiver 11, the interfering transmitter 21, the opposing transmitter 12, and the target receiver 22.

Also, in operation S310, the overlay system may compute a strength of a received signal, received in the interfered receiver 11 from the opposing transmitter 12, using the input parameter.

Also, in operation S310, the overlay system may compute a transmission signal level from a victim link in the interfering transmitter 21. That is, the overlay system may compute a strength of a transmission signal, received in the interfering transmitter 21 from the victim link, based on the interfering transmitter 21 using the input parameter.

In operation S320, the overlay system may determine whether the interfering transmitter 21 transmits a signal. That is, the overlay system may determine whether the interfering transmitter 21 performs transmission based on the strength of the transmission signal and an inputted threshold value. For example, when the strength of the transmission signal is less than the threshold value, the overlay system may determine that the interfering transmitter 21 performs transmission with a same amount of power as transmission power received in a corresponding frequency band. Also, when the strength of the transmission signal is greater than the threshold value, the overlay system may determine that the interfering transmitter 21 does not perform transmission in a corresponding frequency band.

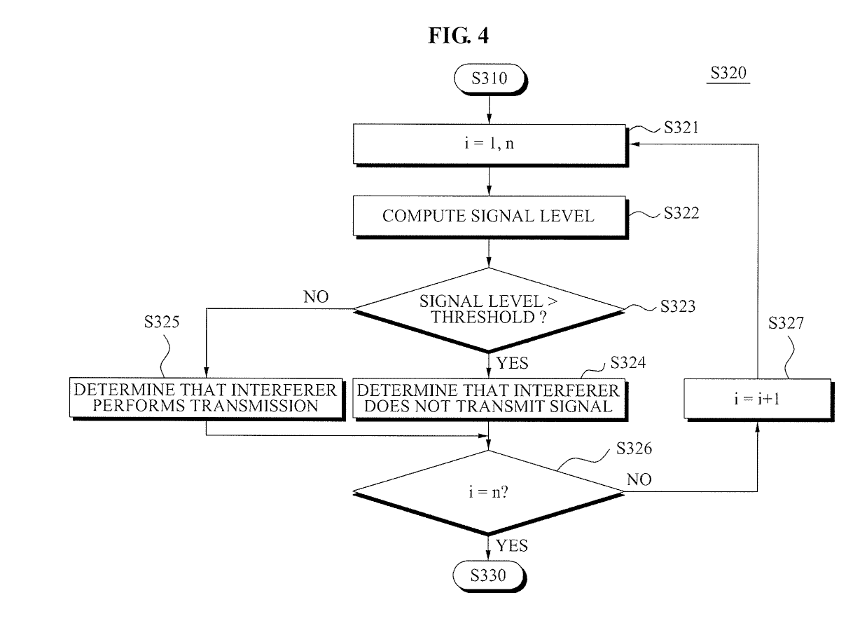

FIG. 4 is a flowchart illustrating an example of an operation of determining whether an interferer performs transmission in the overlay system according to an embodiment of the present invention.

Referring to FIG. 4, in operation S321, the overlay system may receive a number (n) of interfering transmitters 21 which is an interferer.

In operation S322, the overlay system may compute a signal level of a frequency band in an interference link, at a location of the interferer.

In operation S323, the overlay system may compare the computed signal level and a received threshold value.

In operation S324, the overlay system may determine that the interferer does not transmit a signal in a corresponding frequency band, when the signal level is greater than the threshold value.

In operation S325, when the signal level is less than the threshold value, the overlay system may determine that the interferer transmits the signal with a same amount of power as transmission power received in a corresponding frequency band.

In operation S326, the overlay system may determine a number (i) of interferers where whether to perform transmission is determined is equal to the number (n) of interfering transmitters 21.

In operation S327, the overlay system may increase the number (i) of interferers where whether to perform transmission is determined.

The overlay system may repeat the receiving in operation S321 through the increasing in operation S327, and thereby may determine whether the interfering transmitters 21 perform transmission.

In operation S330, the overlay system may compute a Desired Receiving Signal Strength (DRSS) using the input parameter. The DRSS may indicate a strength of a signal received in the interfered receiver 11 from the opposing transmitter 12.

In operation S340, the overlay system may compute an Interfering Receiving Signal Strength (IRSS) depending on whether the interfering transmitter 21 transmits the signal. The IRSS may indicate a strength of an interference signal received in the interfered receiver 11.

In operation S350, the overlay system may compute the probability of interference where the interfering transmitter 21 affects the interfered receiver 11 using the computed strength of the received signal and the computed strength of the interference signal.

For example, in operation S350, when the input parameter is set in a predetermined range, the overlay system may apply each parameter of a corresponding range, compute the DRSS and the IRSS, and divide a number of times that the DRSS/IRSS is equal to or less than the threshold value by a total number of times, to compute the probability of interference.

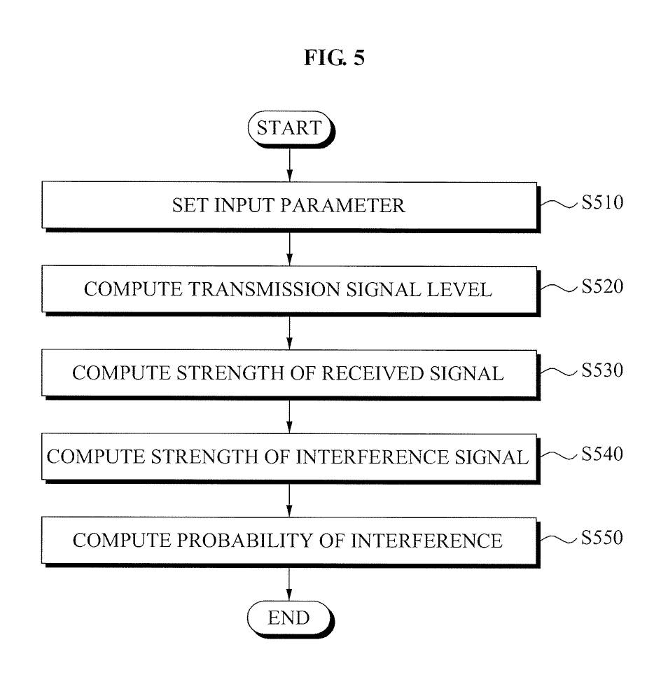

FIG. 5 is a flowchart illustrating a method of computing a probability of interference in an underlay system according to another embodiment of the present invention.

Referring to FIGS. 1 and 5, in operation S510, the underlay system may set an input parameter corresponding to each of an interfered receiver 11, an interfering transmitter 21, opposing transmitter 12, and a target receiver 22. That is, in operation S510, the underlay system may generate the interfered receiver 11, the interfering transmitter 21, the opposing transmitter 12, and the target receiver 22.

Also, in operation S510, the underlay system may compute a strength of a received signal, received in the interfered receiver 11 from the opposing transmitter 12, using the input parameter.

Also, in operation S510, the underlay system may compute a transmission signal level from a victim link in the interfering transmitter 21. That is, the underlay system may compute a strength of a transmission signal, received in the interfering transmitter 21 from the victim link, based on the interfering transmitter 21 using the input parameter.

In operation S520, the underlay system may compute a transmission signal level in a frequency band of an interference link, at a location of the interfering transmitter 21. That is, in operation S520, the underlay system may compute a transmission level of the interfering transmitter 21 based on the computed transmission signal level and the computed strength of the transmission signal.

As described above, the underlay system may compute the transmission signal level in the frequency band of the interference link, and perform transmission based on a transmission power for each inputted level.

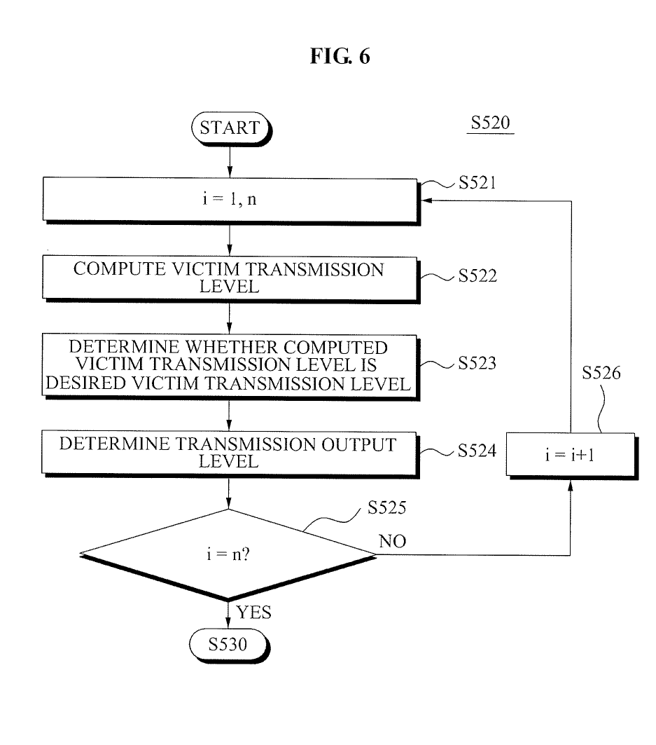

FIG. 6 is a flowchart illustrating an example of an operation of determining an interference transmission level in the underlay system according to another embodiment of the present invention.

Referring to FIG. 6, in operation S521, the underlay system may receive a number (n) of interfering transmitters 21 which is an interferer.

In operation S522, the underlay system may compute a victim transmission level of a frequency band in the interference link, at a location of the interferer.

In operation S523, the underlay system may determine whether the computed victim transmission level is a desired victim transmission level.

In operation S524, the underlay system may determine a transmission output level by referring to the victim transmission level and a transmission power for each inputted level.

For example, when the inputted level is A and B, three cases, that is, when the inputted level is less than A, when the inputted level is greater than A and less than B, and when the inputted level is greater than B, may exist in operation S523. Also, in operation S524, the underlay system may determine the transmission output level for each case. That is, the transmission output level of the interfering transmitter 21 for each inputted level may be determined depending on the received parameter.

In operation S525, the underlay system may determine a number (i) of interferers where the transmission output level is determined is equal to the number (n) of interfering transmitters 21.

In operation S526, the underlay system may increase the number (i) of interferers where the transmission output level is determined, when the number (i) of interferers where the transmission output level is determined is not equal to the number (n) of interfering transmitters 21.

As described above, the underlay system may repeat the receiving in operation S521 through the increasing in operation S526.

In operation S530, the underlay system may compute a DRSS using the input parameter. The DRSS may indicate a strength of a signal received in the interfered receiver 11 from the opposing transmitter 12.

In operation S540, the underlay system may compute an IRSS depending on whether the interfering transmitter 21 transmits the signal. The IRSS may indicate a strength of an interference signal received in the interfered receiver 11.

In operation S550, the underlay system may compute the probability of interference where the interfering transmitter 21 affects the interfered receiver 11 using the computed strength of the received signal and the computed strength of the interference signal.

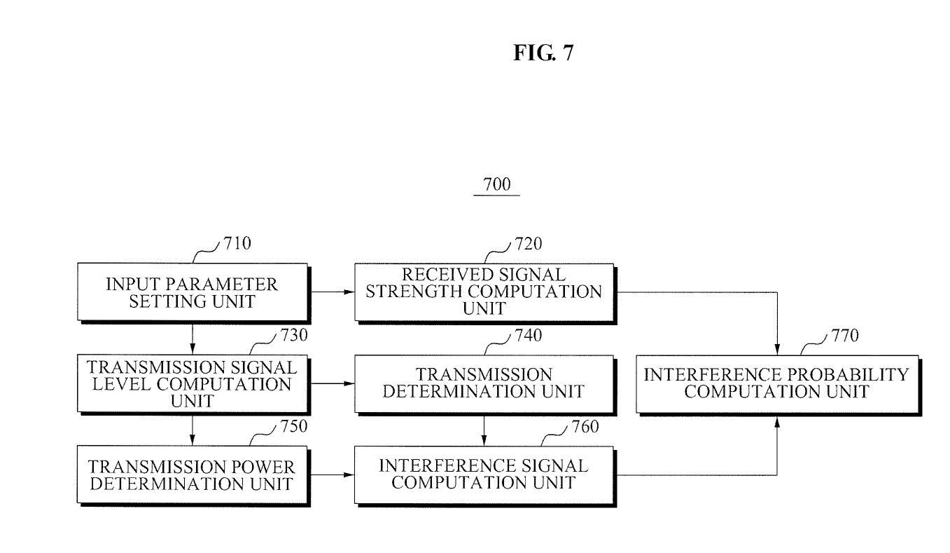

FIG. 7 is a block diagram illustrating a configuration of an apparatus 700 of computing a probability of interference in an overlay system and an underlay system according to an embodiment of the present invention.

Referring to FIG. 7, the apparatus 700 of computing a probability of interference in an overlay system and an underlay system may include an input parameter setting unit 710, a received signal strength computation unit 720, a transmission signal level computation unit 730, a transmission determination unit 740, a transmission power determination unit 750, an interference signal computation unit 760, and an interference probability computation unit 770.

Referring to FIG. 1, the input parameter setting unit 710 may set an input parameter corresponding to each of an interfered receiver 11, an interfering transmitter 21, opposing transmitter 12, and a target receiver 22.

The received signal strength computation unit 720 may compute a strength of a received signal, received in the interfered receiver 11 from the opposing transmitter 12, using the input parameter.

The transmission signal level computation unit 730 may compute a transmission signal level from a victim link in the interfering transmitter 21. That is, the transmission signal level computation unit 730 may compute a strength of a transmission signal, received in the interfering transmitter 21 from the victim link, based on the interfering transmitter 21 using the input parameter. For example, when the input parameter is set in a predetermined range, the transmission signal level computation unit 730 may repeatedly compute the transmission signal level from the victim link by applying a parameter on a number of interferers received in the set range.

The transmission determination unit 740 may determine whether the interfering transmitter 21 transmits a signal in the overlay system. That is, the transmission determination unit 740 may determine whether the interfering transmitter 21 transmits the signal based on the strength of the transmission signal and a received threshold value. For example, when the strength of the transmission signal is greater than the threshold value, the transmission determination unit 740 may determine that the interfering transmitter 21 does not perform transmission in a corresponding frequency band in the overlay system. Also, when the strength of the transmission signal is less than the threshold value, the transmission determination unit 740 may determine that the interfering transmitter 21 performs transmission with a same amount of power as transmission power received in a corresponding frequency band.

The transmission power determination unit 750 may determine a transmission power of the interfering transmitter 21 based on the computed transmission signal level in the underlay system.

The interference signal computation unit 760 may compute a strength of an interference signal, received in the interfered receiver 11, depending on whether the interfering transmitter 21 transmits the signal and the transmission power of the interfering transmitter 21.

The interference probability computation unit 770 may compute the probability of interference where the interfering transmitter affects the interfered receiver using the computed strength of the received signal and the computed strength of the interference signal.

As described above, the apparatus 700 of computing a probability of interference in an overlay system and an underlay system may compute the probability of interference, which is affected on the interfered receiver 11 depending on the strength of the interference signal received in the interfered receiver 11 from the interferer, based on a new wireless communication service using the overlay and underlay scheme.

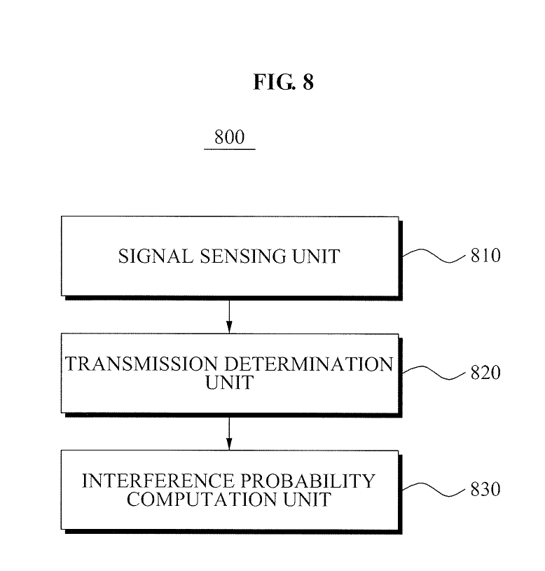

FIG. 8 is a block diagram illustrating a configuration of an apparatus 800 of computing a probability of interference in an overlay system according to another embodiment of the present invention.

Referring to FIG. 8, the apparatus 800 of computing a probability of interference in an overlay system may include a signal sensing unit 810, a transmission determination unit 820, and an interference probability computation unit 830.

The signal sensing unit 810 may sense a strength of an ambient signal before transmitting a signal, when a system using a spectrum based on an overlay scheme is an interferer.

The transmission determination unit 820 may determine whether to transmit the signal based on the sensed strength of the ambient signal.

The interference probability computation unit 830 may compute the probability of interference affected on an interfered receiver depending on a result of the determining whether to transmit.

That is, when the system using the spectrum based on the overlay scheme is the interferer, the apparatus 800 of computing a probability of interference in an overlay system may sense the strength of the ambient signal before transmitting the signal, determine whether to transmit the signal based on the sensed strength of the ambient signal, and thereby may compute the probability of interference.

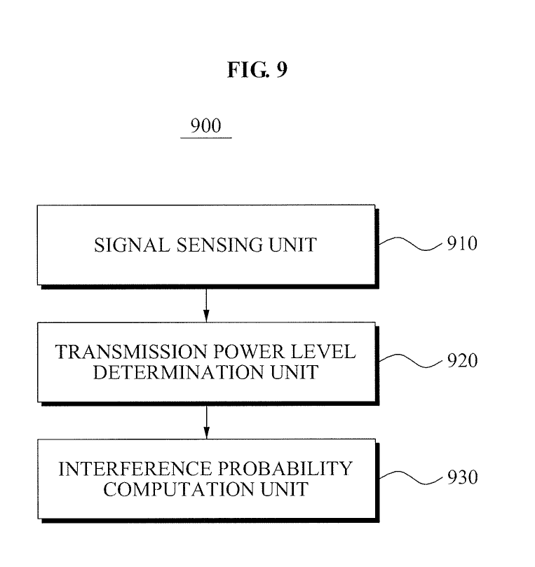

FIG. 9 is a block diagram illustrating a configuration of an apparatus 900 of computing a probability of interference in an underlay system according to still another embodiment of the present invention.

Referring to FIG. 9, the apparatus 900 of computing a probability of interference in an underlay system may include a signal sensing unit 910, a transmission power level determination unit 920, and an interference probability computation unit 930.

The signal sensing unit 910 may sense a strength of an ambient signal before transmitting a signal, when a system using a spectrum based on an underlay scheme is an interferer.

The transmission power level determination unit 920 may determine a transmission power level based on the sensed strength of the ambient signal.

The interference probability computation unit 930 may compute the probability of interference affected on an interfered receiver depending on the determined transmission power level.

That is, when the system using the spectrum based on the underlay scheme is the interferer, the apparatus 900 of computing a probability of interference in an underlay system may sense the strength of the ambient signal before transmitting the signal, determine the transmission power level, and compute the probability of interference.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of computing a probability of interference in an overlay system and an underlay system, the method comprising:
setting an input parameter corresponding to each of an interfered receiver, an interfering transmitter, an opposing transmitter, and a target receiver;
computing a strength of a received signal, received in the interfered receiver from the opposing transmitter, using the input parameter;
computing a transmission signal level from a victim link in the interfering transmitter;
determining whether the interfering transmitter transmits a signal in the overlay system;
determining a transmission power of the interfering transmitter based on the computed transmission signal level in the underlay system;
computing a strength of an interference signal, received in the interfered receiver, depending on whether the interfering transmitter transmits the signal and the transmission power of the interfering transmitter; and
computing the probability of interference where the interfering transmitter affects the interfered receiver using the computed strength of the received signal and the computed strength of the interference signal.

2. The method of claim 1, wherein the computing of the transmission signal level computes a strength of a transmission signal, received in the interfering transmitter from the victim link, based on the interfering transmitter using the input parameter.

3. The method of claim 2, wherein the determining of whether the interfering transmitter performs transmission determines whether the interfering transmitter performs transmission based on the strength of the transmission signal and an inputted threshold value.

4. The method of claim 3, wherein, when the strength of the transmission signal is less than the threshold value, the determining of whether the interfering transmitter performs transmission determines that the interfering transmitter performs transmission with a same amount of power as transmission power received in a corresponding frequency band.

5. The method of claim 3, wherein, when the strength of the transmission signal is greater than the threshold value, the determining of whether the interfering transmitter performs transmission determines that the interfering transmitter does not perform transmission in a corresponding frequency band.

6. The method of claim 1, wherein, when the input parameter is set in a predetermined range, the computing of the transmission signal level and the determining of whether the interfering transmitter performs transmission are repeated by applying a parameter on a number of interferers received in the set range.

7. The method of claim 2, wherein the determining of the transmission power determines a transmission level of the interfering transmitter based on the transmission signal level and the computed strength of the transmission signal.

8. The method of claim 7, further comprising:
associating the computed strength of the transmission signal in the victim link with a level of the receiving signal, assigning a transmission signal level for each level, and performing transmission by the interfering transmitter.

9. A method of computing a probability of interference in an overlay system, the method comprising:
sensing a strength of an ambient signal before transmitting a signal, when a system using a spectrum based on an overlay scheme is an interferer;
determining whether to transmit a signal based on the sensed strength of the ambient signal; and
computing the probability of interference affecting an interfered receiver depending on a result of the determining whether to transmit.

10. A method of computing a probability of interference in an underlay system, the method comprising:
sensing a strength of an ambient signal before transmitting a signal, when a system using a spectrum based on an underlay scheme is an interferer;
determining a transmission power level based on the sensed strength of the ambient signal: and
computing the probability of interference affected on an interfered receiver depending on the determined transmission power level.

11. An apparatus of computing a probability of interference in an overlay system and an underlay system, the apparatus comprising:
an input parameter setting unit to set an input parameter corresponding to each of an interfered receiver, an interfering transmitter, opposing transmitter, and a target receiver;
a received signal strength computation unit to compute a strength of a received signal, received in the interfered receiver from the opposing transmitter, using the input parameter;
a transmission signal level computation unit to compute a transmission signal level from a victim link in the interfering transmitter;
a transmission determination unit to determine whether the interfering transmitter transmits a signal in the overlay system;
a transmission power determination unit to determine a transmission power of the interfering transmitter based on the computed transmission signal level in the underlay system;
an interference signal computation unit to compute a strength of an interference signal, received in the interfered receiver, depending on whether the interfering transmitter transmits the signal and the transmission power of the interfering transmitter; and
an interference probability computation unit to compute the probability of interference where the interfering transmitter affects the interfered receiver using the computed strength of the received signal and the computed strength of the interference signal.

12. An apparatus of computing a probability of interference in an overlay system, the apparatus comprising:
a signal sensing unit to sense a strength of an ambient signal before transmitting a signal, when a system using a spectrum based on an overlay scheme is an interferer;
a transmission determination unit to determine whether to transmit the signal based on the sensed strength of the ambient signal; and
an interference probability computation unit to compute the probability of interference affected on an interfered receiver depending on a result of the determining whether to transmit.

13. An apparatus of computing a probability of interference in an underlay system, the apparatus comprising:
a signal sensing unit to sense a strength of an ambient signal before transmitting a signal, when a system using a spectrum based on an underlay scheme is an interferer:
a transmission power level determination unit to determine a transmission power level based on the sensed strength of the ambient signal; and
an interference probability computation unit to compute the probability of interference affected on an interfered receiver depending on the determined transmission power level.
